(19) United States
(12) Patent Application Publication
(10) Pub. No.: US 2024/0411613 A1
(43) Pub. Date: Dec. 12, 2024

(54) SELF-SOVEREIGN RESOURCE TRACKING FOR DOMAIN ISOLATION

(71) Applicant: QUALCOMM Incorporated, San Diego, CA (US)

(72) Inventor: Osman KOYUNCU, San Diego, CA (US)

(21) Appl. No.: 18/544,153

(22) Filed: Dec. 18, 2023

Related U.S. Application Data
(60) Provisional application No. 63/471,942, filed on Jun. 8, 2023.

(51) Int. Cl. G06F 9/50

(52) U.S. Cl. CPC G06F 9/5077

(57) ABSTRACT

A method for self-sovereign resource tracking for domain isolation includes receiving, by a controller unit, a request by an entity to access a first entry in the resource tracking table. The first entry corresponds to a first resource of a computing system. A first identifier associated with the entity is detected. The controller unit compares the first identifier with first owner information specified in the first entry of the resource tracking table. The controller unit controls access from the entity to the first entry of the resource tracking table based on the comparison of the first identifier and the first owner information.

### CROSS-REFERENCE TO RELATED APPLICATION

The present application claims the benefit of U.S. Provisional Patent Application No. 63/471,942, filed on Jun. 8, 2023, and titled “SELF-PROTECTING RESOURCE TRACKING FOR DOMAIN ISOLATION,” the disclosure of which is expressly incorporated by reference in its entirety.

### FIELD OF DISCLOSURE

Aspects of the present disclosure relate to computing devices, and more specifically to self-sovereign resource tracking for domain isolation.

### BACKGROUND

The landscape of the computing environment is rapidly changing and includes a growing number of stakeholders employing varying trust models. These complex relationships may vary greatly based on different product categories, for example servers, compute, mobile, embedded, etc. Some stakeholders may have conflicting security requirements. Static isolation of assets in a physical address space is generally not scalable and cannot support use cases with a large memory footprint. Thus, managing data security in the complex computing environment is challenging.

### SUMMARY

The present disclosure is set forth in the independent claims, respectively. Some aspects of the disclosure are described in the dependent claims.

In some aspects of the present disclosure, a method for updating a resource tracking table includes receiving, by a controller unit (e.g., domain control isolation unit), a request by an entity to access a first entry in the resource tracking table. The first entry corresponds to a first resource of a computing system. The method still further includes detecting a first identifier associated with the entity. The method also includes comparing, by the controller unit, the first identifier with first owner information specified in the first entry of the resource tracking table. The method further includes controlling, by the controller unit, access from the entity to the first entry based on the comparing.

Various aspects of the present disclosure are directed to an apparatus including means for receiving, by a controller unit (e.g., domain control isolation unit), a request by an entity to access a first entry in the resource tracking table. The first entry corresponds to a first resource of a computing system. The apparatus further includes means for detecting a first identifier associated with the entity. The apparatus further includes means for comparing, by the controller unit, the first identifier with first owner information specified in the first entry of the resource tracking table. The apparatus further includes means for controlling, by the controller unit, access from the entity to the first entry based on the comparing.

In some aspects of the present disclosure, a non-transitory computer-readable medium with non-transitory program code recorded thereon is disclosed. The program code is executed by a processor and includes program code to receive, by a controller unit, a request by an entity to access a first entry in the resource tracking table. The first entry corresponds to a first resource of a computing system. The program code still further includes program code to detect a first identifier associated with the entity. The program code also includes program code to compare, by the controller unit, the first identifier with first owner information specified in the first entry of the resource tracking table. The program code further includes program code to control, by the controller unit (e.g., domain control isolation unit), access from the entity to the first entry based on the comparing.

Various aspects of the present disclosure are directed to an apparatus having at least one memory for storing a resource tracking table. The apparatus also has a controller unit (e.g., domain control isolation unit) coupled to the at least one memory. The controller unit is configured to receive a request by an entity to access a first entry in the resource tracking table. The first entry corresponds to a first resource of a computing system. The controller unit is also configured to detect a first identifier associated with the entity. The controller unit is additionally configured to compare the first identifier with first owner information specified in the first entry of the resource tracking table. The controller unit is also configured to control access from the entity to the first entry based on the comparing.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), which includes a domain control isolation unit, in accordance with aspects of the present disclosure.

FIG. 2 is a block diagram illustrating an example architecture for self-sovereign resource tracking using the domain control isolation unit of FIG. 1, in accordance with various aspects of the present disclosure.

FIG. 3 is a block diagram illustrating a high-level overview of an example software stack, in accordance with various aspects of the present disclosure.

FIG. 4 is state diagram illustrating an example resource ownership lifecycle, in accordance with various aspects of the present disclosure.

FIG. 5 is a flow diagram illustrating an example process performed, for example, by a computing device, in accordance with various aspects of the present disclosure.

FIG. 6 is a block diagram showing an exemplary wireless communications system in which a configuration of the present disclosure may be advantageously employed.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

A domain refers to a collection of resources in a platform or system-on-a-chip (SoC) that are under the control of a distinct controlling authority and are isolated from other domains on the same platform. Resources may include (but are not limited to) peripheral devices, internal or external memory regions (e.g., a page in memory), registers, direct memory access (DMA) channels, or input/output I/O ports, for example. Resources may be addressed in the platform using a system physical address that is decoded by various interconnect components. System physical addresses (sPA) uniquely address resources in the system.

An initiator is a hardware (HW) entity that can issue transactions to the system interconnect to access a resource. Access to a resource can be read from or write to the resource.

Legitimate use of a resource by an initiator refers to allowed read-only (RO), read-write (RW), or execute-only (XO) access to the resource such that an allowed use policy (as to whether the use is RO, RW, or XO) is dictated by the domain “owner.” The legitimate use may also include RO, RW, or XO access to a particular domain's resource from another domain (e.g., a sharing policy).

Domain isolation in computing refers to separating different computing environments or domains to enhance security and prevent unauthorized access or data breaches. Domain isolation involves creating distinct boundaries between resources such as systems, networks, or applications to isolate them from each other for access control or security reasons, for example. The isolation aims to ensure the confidentiality and integrity of a particular domain's private or shared resources.

In conventional architectures, there is no clear separation between the ownership of a resource and an access control policy for the resource (e.g., who can access the resource). Additionally, there is no central authority for tracking the ownership of a resource. Rather, access control policies, as well as ownership, may be enforced by higher privileged software entities.

Some conventional approaches aim to create trusted execution environments. A trusted execution environment is a secure area of a processor in which code and data may be protected to prevent such code and data from being replaced or modified by unauthorized entities. However, trust relationships may be complex and may include multiple stakeholders with conflicting security demands. For instance, content protection, health management, biometric authentication, and other business areas may demand higher levels of assurance of data security. As such, it may be challenging to determine which entities may be trusted to access and modify information in the trusted environment. Furthermore, static or hard isolation in the sPA may hinder usability. For instance, performance may be degraded, while memory footprint and power consumption may be increased.

Accordingly, to address these and other challenges, aspects of the present disclosure are directed to self-sovereign resource tracking for domain isolation. In accordance with various aspects of the present disclosure, a scalable technique for creating distrusting execution environments is provided. That is, rather than creating trusted execution environments, aspects of the present disclosure provide the capability for stakeholders to minimize trust attainment, and instead focus on attributes of resources such as the identity of the owner, sharing policy, and security properties to be enforced.

Resource tracking may separate the owner of the resource from legitimate allowed users or consumers of the resource, where consumption may refer to read-only, read-write, or execute-only access to the resource. Owners of the resource may be enabled to dictate an excess of legitimate consumers or users. In some aspects, owners may temporally revoke their own access to the resource, for example, if deemed necessary by the owner.

Aspects of the present disclosure provide for a domain identifier construction that is immutable to prevent higher privilege levels from attacking lower privilege levels, for example, by masquerading as the victim's identifier. Additionally, the techniques of the present disclosure may be extensible to support the notion of worlds, which may be akin to a trust zone, etc.

In order to achieve the domain boundaries, some have attempted protection tables to track access to a page, but may lack a notion of ownership of a page. Aspects of the present disclosure utilize hardware to enforce a property that only the owner may modify a resource tracking table (rather than a higher privileged software (SW) entity).

Particular aspects of the subject matter described in this disclosure can be implemented to realize one or more of the following potential advantages. In some examples, the described techniques, such as a domain control isolation unit for managing access to the resource tracking table, may enable increased access control capabilities and data security.

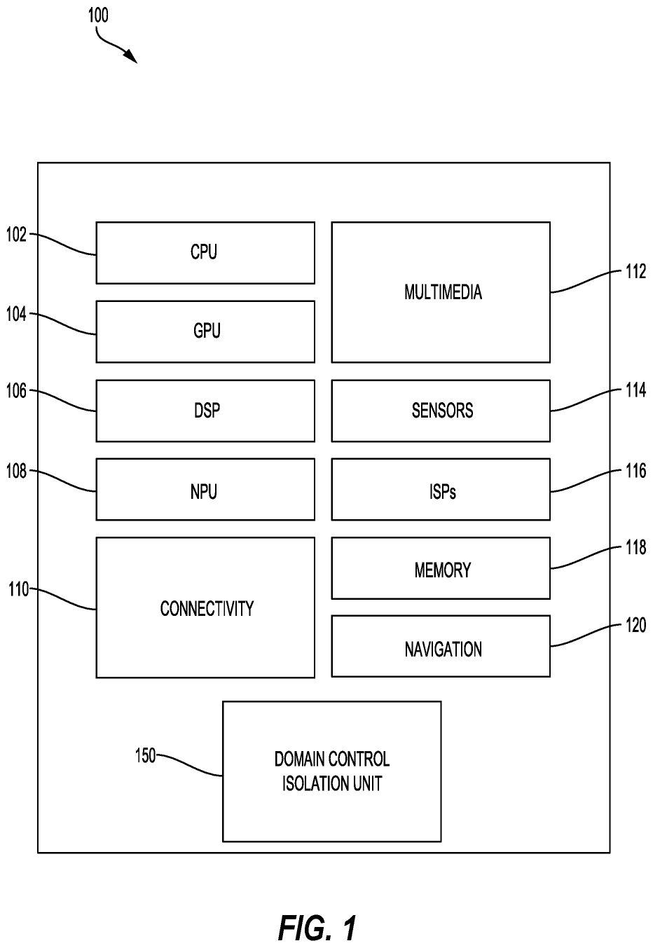

FIG. 1 illustrates an example implementation of a host system-on-a-chip (SoC) 100, which includes a domain control isolation unit 150, in accordance with various aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) architecture such as an advanced RISC machine (ARM) and RISC-V (RISC-five), a microprocessor, or some other type of processor. The NPU 108 may be based on an ARM instruction set or a RISC machine.

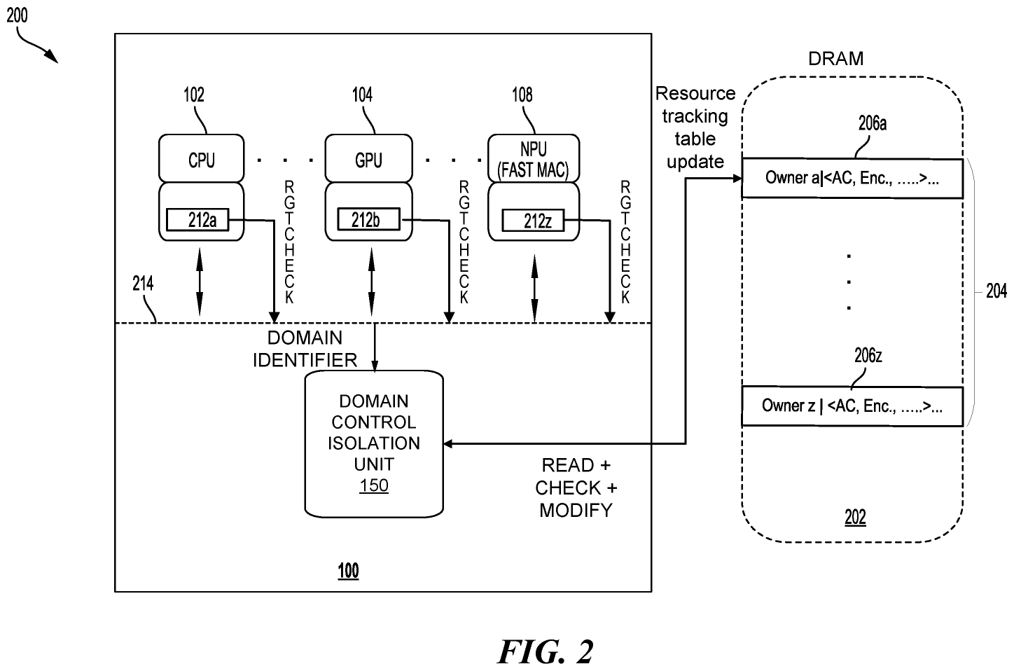

FIG. 2 is a block diagram illustrating an example architecture 200 for self-sovereign resource tracking using the domain control isolation unit 150 of FIG. 1, in accordance with various aspects of the present disclosure. As shown in FIG. 2, an SoC, such as the SoC 100, may be adapted to include a hardware block domain control isolation unit 150. The domain control isolation unit 150 may manage a resource tracking table 204. The resource tracking table 204 may be stored in a memory, such as a dynamic random access memory (DRAM) 202, or in register files associated with one or more initiators (e.g., CPU 102, GPU 104, or NPU 108).

The resource tracking table 204 may include an entry 206a-z of resources (e.g., an application) in the system. The resources may include memory ((e.g., internal memory (e.g., 118 of FIG. 1) or external memory regions (e.g., a page in DRAM)), registers, direct memory access (DMA) channels, input/output (IO) ports, peripheral devices, or other devices that are addressable by a processor of the computing system (e.g., CPU 102), for example. Each resource may be addressed in the system physical address space. Each entry 206a-z in the resource tracking table 204 may specify an owner of the resource, as well as a set of properties associated with the resource. The properties may, for example, include an access control policy for the resource (e.g., RO, RW, XO, or shared), encryption information (e.g., an encryption key identifier for encrypted memory), resource attributes and other resource properties. The resource tracking table 204 may separate the concept of ownership of resources from legitimate allowed consumers of the respective resources. Consumption may refer to access (e.g., RO, RW, or XO) to the resources and the owner of the resource may dictate the legitimate consumers and the type of access allowed.

The ownership of the resources listed in the resource tracking table 204 may be considered self-protected. That is, unlike conventional approaches, the resources listed in the resource tracking table 204 are not protected by a higher privileged software entity. Instead, ownership of a resource may be enforced by the domain control isolation unit 150 at each agent or initiator attempting to access or modify an entry in the resource tracking table 204. The resource tracking table 204 may be populated at the system boot of a computing system including SoC 100 or in an order in which domains are established in the computing system, for example.

After a resource has been added to the resource tracking table 204, the resource may be accessed at the location according to a system physical address based on the domain. Each domain may have a unique domain identifier. In some aspects, the domain identifier may include a portion that identifies a privilege level. For instance, in one example, a 16-bit domain identifier may include two bits that indicate a privilege level in the software stack. Of course, any number of bits may be allocated for identifying privilege or other properties for each resource according to design preference, for example.

The domain control isolation unit 150 may check a domain identifier for an entity attempting to access a resource. The check may be performed at the initiator (e.g., CPU 102) being used for such access. The domain control isolation unit 150 may perform a tracking table lookup using the system physical address. The domain control isolation unit 150 may check whether the entity is the owner of the resource. For instance, the domain control isolation unit 150 may receive, from the initiator, the domain identifier attempting access. The domain control isolation unit 150 may also read the owner information included in the resource tracking table entry (e.g., 206a). Then, the domain control isolation unit 150 may compare the received domain identifier with the owner information in the resource tracking table 204. If the domain identifier matches the owner information, the domain control isolation unit 150 may permit access to the resource. If the domain identifier does not match the owner information, the domain control isolation unit 150 may determine if the access control policy of the resource (included in the entry (e.g., 206a)) of the resource tracking table 204 permits access by the domain identifier. If access is permitted, the domain control isolation unit 150 may permit access in accordance with the access control policy (e.g., RO, RW, XO, or shared). Otherwise, the domain control isolation unit 150 may deny access to the resource.

The domain control isolation unit 150 may also control access to or modification of the resource tracking table 204. In this case, only the owner of the resource may update the entry (e.g., 206a) in the resource tracking table 204 for a corresponding resource of the computing system. For example, the domain control isolation unit 150 may receive the domain identifier information from an initiator (e.g., CPU 102) through which access of the entry (e.g., 206a) in the resource tracking table 204 is attempted. In response, the domain control isolation unit 150 may perform a check operation in which the domain control isolation unit 150 may compare the domain identifier with the owner information included in the entry (e.g., 206a) of the resource tracking table 204. If the domain control isolation unit 150 determines that the domain identifier matches the owner information in the entry of the resource tracking table 204, then the domain control isolation unit 150 may permit access to the entry (e.g., 206a). For instance, the domain control isolation unit 150 may allow access and/or modification of the properties (e.g., access control or encryption key) in the entry (e.g., 206a) for the corresponding resource.

On the other hand, if the domain control isolation unit 150 determines the domain identifier does not match the owner information in the entry (e.g., 206a) of the resource tracking table 204, the domain control isolation unit 150 may deny access to or updating of the entry of the resource tracking table 204.

In some aspects, an owner lock bit may provide further security for the resource tracking table 204. For instance, each entry may include an owner lock bit, that when set, may restrict modification of the properties (e.g., access control policy) in the entry (e.g., 206a) of the resource tracking table 204. For example, the domain control isolation unit 150 may check the entry (e.g., 206a) to be accessed, and if the owner lock bit is set (e.g., set to one), then updating the properties (e.g., access control policy), even by the owner, may be restricted. In doing so, unintentional modification of the properties, for example, may be reduced. In some aspects, the owner of the resource may also reset the lock bit (e.g., set to zero) to re-enable modification of the properties in the entry (e.g., 206a).

In some aspects, the entry (e.g., 206a-z) for the particular resource may be stored in cache memory (e.g., 212a-z) for the particular resource. For example, as shown in FIG. 2, an entry (e.g., 206a-z) of the resource tracking table 204 for the CPU 102 may be provided via a system interconnect 214 and may be stored in a local memory (e.g., storing shown using the double-ended arrows) such as the cache memory (e.g., 212a-z) of the CPU 102. The system interconnect 214 may comprise (but is not limited to) a system bus coupling the domain control isolation unit 150 with each of the initiators (e.g., 102, 104, 108) as well as the corresponding local memories (e.g., 212a-z). In doing so, each of the initiators (e.g., CPU 102, GPU 104, or NPU 108) may enforce the access control policy for each of the resources (e.g., a page in memory, registers, or peripheral devices) by implementing a resource grant check (RGTCHECK) operation.

In some aspects, each initiator (e.g., CPU 102, GPU 104, or NPU 108) may also enforce the access control policy by performing a tracking table lookup with respect to a resource to be accessed by a consumer. If the owner permits access (e.g., RO) to the entry, the access control policy listed in the entry may be checked. For instance, the domain identifier for the consumer may be compared to a shared access list in the access control policy. If the domain identifier is included in the shared access list, the consumer may be permitted access to the resource. Otherwise, access to the resource may be denied. However, it should be understood that although the initiators (e.g., CPU 102, GPU 104, or NPU 108) may be permitted to enforce the access control policy for a resource, the domain control isolation unit 150 continues to enforce restrictions on accessing and modifying the entries (e.g., 206a-z) of the resource tracking table 204.

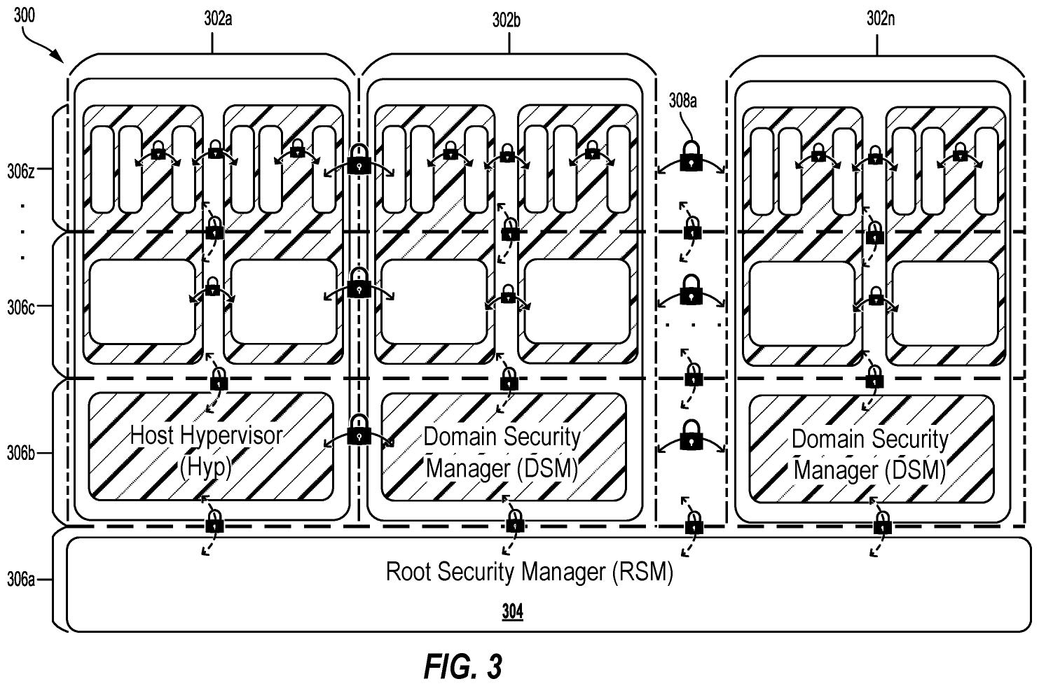

FIG. 3 is a block diagram illustrating a high-level overview of an example software stack 300, in accordance with various aspects of the present disclosure. Referring to FIG. 3, the example software stack 300 may be partitioned into multiple domains 302a-n. The multiple domains 302a-n may be managed by a root security manager 304. Each of the domains 302a-n may include multiple resources as well as multiple privilege levels 306a-z. The root security manager 304 may be the highest privileged entity in the system. That is, the root security manager 304 may be in the highest privilege level 306a in the system (e.g., exception level (EL) 3 or monitor mode) followed in sequence by a privilege level 306b (e.g., EL2 or hypervisor mode) through privilege level 306z (e.g., EL0 (used for applications) or virtual user mode).

As shown in FIG. 3, access control may be maintained at each privilege level (e.g., 306a-z) as well as between domains (e.g., 302a-z). However, unlike conventional approaches, the higher privilege entity and levels may also be subject to access controls. That is, higher privilege levels may not be treated as a trusted environment for allow access. For example, an entity with access to a resource in the privilege level 306b (e.g., a hypervisor) may be denied access to a resource in a privilege level 306c. In another example, an entity in the privilege level 306a (e.g., the root security manager 304) may be denied access to resources at the lowest privilege level 306z (e.g., EL0). Further access control may be achieved as resources in the same domain (e.g., 302a-z) and/or privilege level (e.g., 306a-z) may enforce access control relative to other resources in the domain/privilege level. For example, in a domain 302a, an entity for a first resource (e.g., an application) may be denied access to other resources (e.g., an application) in the same privilege level 306z.

That is, aspects of the present disclosure may enable increased granularity in access control. For instance, domain isolation (shown by way of lock elements 308a-z (one of which is labeled (308a) for ease of illustration)) may be realized between any number of resources within the computing system without regard to privilege level, for example. Instead, ownership of each resource may be defined and access may be separately controlled using the resource tracking table (e.g., 204). Accordingly, aspects of the present disclosure may increase flexibility in configuring isolation boundaries.

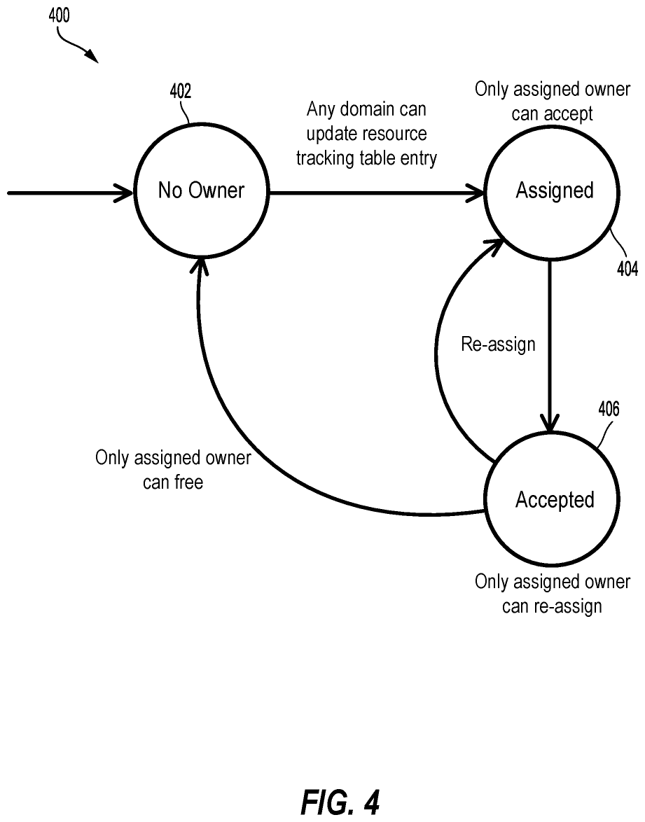

FIG. 4 is state diagram illustrating an example resource ownership lifecycle 400, in accordance with various aspects of the present disclosure. Referring to FIG. 4, at state 402, a resource may be initialized to a no owner state. For example, a resource may be initialized to the no owner state at system boot up. In the no owner state, any domain may update the corresponding entry (e.g., 206a) for the resource in a resource tracking table (e.g., 204). For instance, any entity in the system may change the owner field for the resource. The entity may assign the resource to itself or assign the resource to another domain, for example.

In some aspects, the owner of a resource and the resource properties may be initialized to a predetermined default setting. For instance, an entry in the resource tracking table (e.g., 204) for a resource may be initialized to a “no-owner” state (e.g., the owner field in the entry (e.g., 206z) may be set to “no owner”).

At state 404, the resource may be assigned an owner. In this state, only the assigned owner may be permitted to accept ownership of the resource. If the assigned owner accepts, the owner may modify the entry including the properties (e.g., access control policy) for the resource. At state 406, the assigned owner of a resource may reassign ownership to another domain. As such, the newly assigned domain may be permitted to access and modify the entry in the resource tracking table (e.g., 204). However, in some aspects, assignments may be provided on an opt-in basis. That is, an assigned entity (domain) may not become an owner until the entity accepts the assignment. This may reduce and, in some aspects, prevent attack scenarios where a domain is silently assigned a resource without consent and is subverted to use that resource.

In some aspects an owner may relinquish ownership of a resource by freeing the resource. Freeing a resource may refer to changing the owner in an entry (e.g., 206a) to “no owner” (returning to state 402). If there is a current owner of the resource then only that owner can mark the resource to be owned by “no owner” to free the resource. Then, if an owner for a resource is listed in the entry (e.g., 206a) as “no owner,” any entity may claim ownership of the resource.

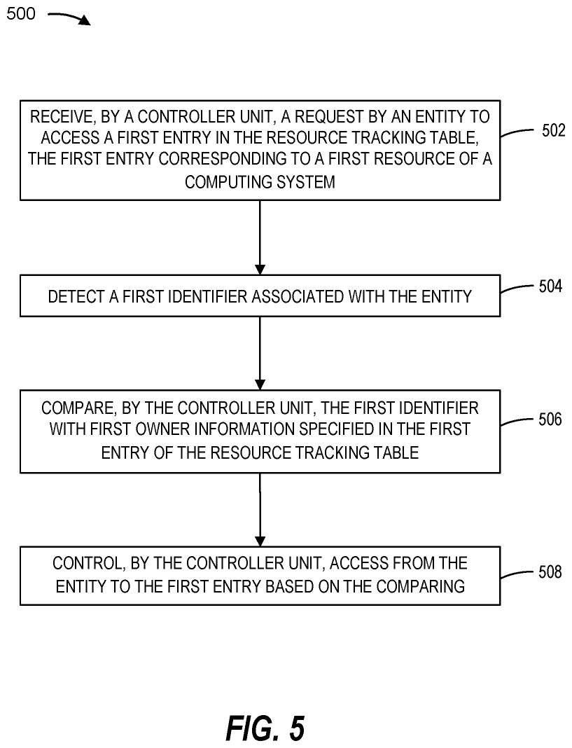

FIG. 5 is a flow diagram illustrating an example process 500 performed, for example, by a computing device, in accordance with various aspects of the present disclosure. The process 500 may be performed by a controller unit such as the domain control isolation unit 150. At block 502, the example process 500 includes receiving, by a controller unit, a request by an entity to access a first entry in the resource tracking table. The first entry corresponds to a first resource of a computing system.

At block 504, the process 500 includes detecting a first identifier associated with the entity. For instance, as described with reference to FIG. 2, the domain control isolation unit 150 may receive a domain identifier information from an initiator (e.g., CPU 102) through which access of the entry (e.g., 206a) in the resource tracking table 204 is attempted. In some aspects, the detection may also be conducted by the initiators (e.g., CPU 102).

At block 506, the process 500 includes comparing, by the controller unit, the first identifier with first owner information specified in the first entry of the resource tracking table. For example, as described with reference to FIG. 2, in response a request to access an entry (e.g., 206a) of the resource tracking table 204, the domain control isolation unit 150 may perform a check operation in which the domain control isolation unit 150 may compare the domain identifier with the owner information included in the entry (e.g., 206a) of the resource tracking table 204.

The domain control isolation unit 150 may then perform a check operation comparing the domain identifier with the owner information included in the entry (e.g., 206a) of the resource tracking table 204.

At block 508, the process 500 includes controlling, by the controller unit, access from the entity to the first entry based on the comparing. As described, for instance, with reference to FIG. 2, if the domain control isolation unit 150 determines that the domain identifier matches the owner information in the entry of the resource tracking table 204, then the domain control isolation unit 150 may permit access to the entry (e.g., 206a). For instance, the domain control isolation unit 150 may allow access and/or modification of the properties (e.g., access control or encryption key) in the entry (e.g., 206a) for the corresponding resource. On the other hand, if the domain control isolation unit 150 determines that the domain identifier does not match the owner information in the entry (e.g., 206a) of the resource tracking table 204, the domain control isolation unit 150 may deny access to or updating of the entry of the resource tracking table 204.

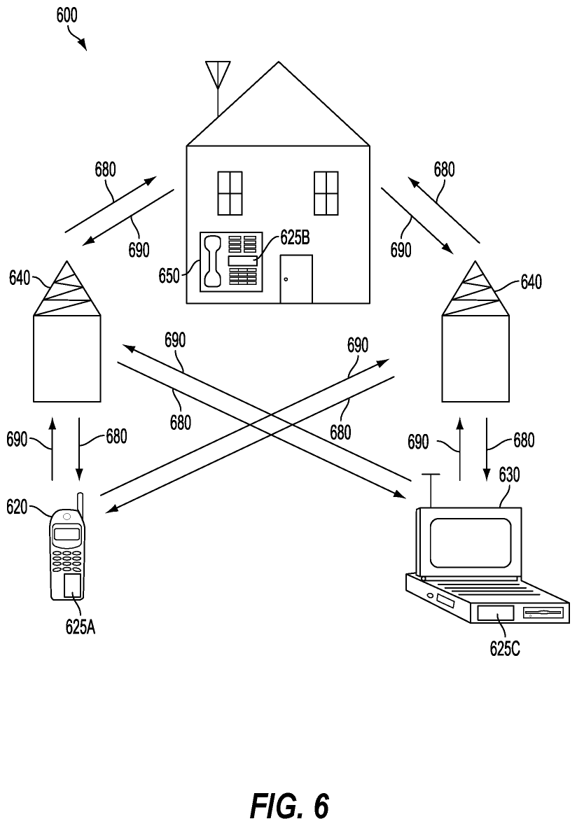

FIG. 6 is a block diagram showing an exemplary wireless communications system 600, in which an aspect of the present disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625C that include the disclosed domain control isolation unit. It will be recognized that other devices may also include the disclosed domain control isolation unit such as the base stations, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed domain control isolation unit.

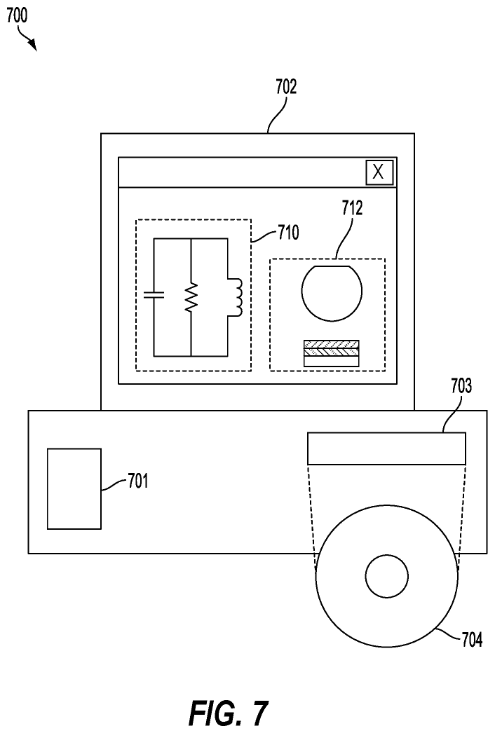

FIG. 7 is a block diagram illustrating a design workstation used for circuit, layout, and logic design of a semiconductor component, such as the domain control isolation unit disclosed above. A design workstation 700 includes a hard disk 701 containing operating system software, support files, and design software such as Cadence or OrCAD. The design workstation 700 also includes a display 702 to facilitate a circuit design 710 or a radio frequency integrated circuit (RFIC) 712. A storage medium 704 is provided for tangibly storing the circuit design 710 or the RFIC 712. The circuit design 710 or the RFIC 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit design 710 or the RFIC 712 by decreasing the number of processes for designing semiconductor wafers.

Implementation examples are included in the following numbered clauses.

1. An apparatus, comprising:
at least one memory for storing a resource tracking table; and
a controller unit coupled to the at least one memory, the controller unit is configured to:
receive a request by an entity to access a first entry in the resource tracking table, the first entry corresponding to a first resource of a computing system;
detect a first identifier associated with the entity;
compare the first identifier with first owner information specified in the first entry of the resource tracking table; and
control access from the entity to the first entry based on the comparing.

2. The apparatus of clause 1, in which the entity has a higher privilege level than a privilege level associated with the first resource of the first entry and the controller unit denies access to the first entry by the entity if the first identifier does not match the first owner information.

3. The apparatus of clause 1 or 2, in which the controller unit permits the entity to access or modify the first entry if the first identifier matches the first owner information.

4. The apparatus of any of clauses 1-3, in which the entity has access privileges for at least a second resource in a same domain as the first resource of the first entry and the controller unit denies access by the entity.

5. The apparatus of any of clauses 1-4, in which the entity has a lower privilege level than a privilege level of the first resource of the first entry and the controller unit permits the entity to update the first entry based on the comparing.

6. The apparatus of any of clauses 1-5, in which the first entry includes a set of properties associated with the first resource and the controller unit denies access to the first entry corresponding to the first resource if the first identifier does not match the first owner information.

7. The apparatus of any of clauses 1-6, in which the set of properties include one or more of an access control policy or an encryption key associated with the first resource.

8. The apparatus of any of clauses 1-7, in which the access control policy specifies that the entity has access privileges to the first resource and the controller unit denies access to the first entry if the first identifier does not match the first owner information.

9. The apparatus of any of clauses 1-8, in which the first entry is stored in memory or register files associated with an initiator.

10. The apparatus of any of clauses 1-9, in which the resource tracking table includes a second entry corresponding to a second resource and the first owner information of the first entry is different than a second owner information of the second entry.

11. A method for updating a resource tracking table comprising:
receiving, by a controller unit, a request by an entity to access a first entry in the resource tracking table, the first entry corresponding to a first resource of a computing system;
detecting a first identifier associated with the entity;
comparing, by the controller unit, the first identifier with first owner information specified in the first entry of the resource tracking table; and
controlling, by the controller unit, access from the entity to the first entry based on the comparing.

12. The method of clause 11, in which the entity has a higher privilege level than a privilege level associated with the first resource of the first entry and the controller unit denies access to the first entry by the entity if the first identifier does not match the first owner information.

13. The method of clause 11 or 12, in which the controller unit permits the entity to access or modify the first entry if the first identifier matches the first owner information.

14. The method of any of clauses 11-13, in which the entity has access privileges for at least a second resource in a same domain as the first resource of the first entry and the controller unit denies access by the entity.

15. The method of any of clauses 11-14, in which the entity has a lower privilege level than a privilege level of the first resource of the first entry and the controller unit permits the entity to update the first entry based on the comparing.

16. The method of any of clauses 11-15, in which the first entry includes a set of properties associated with the first resource and the controller unit denies access to the first entry corresponding to the first resource if the first identifier does not match the first owner information.

17. The method of any of clauses 11-16, in which the set of properties include one or more of an access control policy or an encryption key associated with the first resource.

18. The method of any of clauses 11-17, in which the access control policy specifies that the entity has access privileges to the first resource and the controller unit denies access to the first entry if the first identifier does not match the first owner information.

19. The method of any of clauses 11-18, in which the first entry is stored in memory or register files associated with an initiator.

20. The method of any of clauses 11-19, in which the resource tracking table includes a second entry corresponding to a second resource and the first owner information of the first entry is different than a second owner information of the second entry.

21. A non-transitory computer-readable medium having program code recorded thereon, the program code executed by a processor and comprising:
program code to receive, by a controller unit, a request by an entity to access a first entry in a resource tracking table, the first entry corresponding to a first resource of a computing system;
program code to detect a first identifier associated with the entity;
program code to compare, by the controller unit, the first identifier with first owner information specified in the first entry of the resource tracking table; and
program code to control, by the controller unit, access from the entity to the first entry based on the comparing.

22. The non-transitory computer-readable medium of clause 21, in which the entity has a higher privilege level than a privilege level associated with the first resource of the first entry and the controller unit denies access to the first entry by the entity if the first identifier does not match the first owner information.

23. The non-transitory computer-readable medium of clause 21 or 22, in which the controller unit permits the entity to access or modify the first entry if the first identifier matches the first owner information.

24. The non-transitory computer-readable medium of any of clauses 21-23, in which the entity has access privileges for at least a second resource in a same domain as the first resource of the first entry and the controller unit denies access by the entity.

25. The non-transitory computer-readable medium of any of clauses 21-24, in which the entity has a lower privilege level than a privilege level of the first resource of the first entry and the controller unit permits the entity to update the first entry based on the comparing.

26. The non-transitory computer-readable medium of any of clauses 21-25, in which the first entry includes a set of properties associated with the first resource and the controller unit denies access to the first entry corresponding to the first resource if the first identifier does not match the first owner information.

27. The non-transitory computer-readable medium of any of clauses 21-26, in which the set of properties include one or more of an access control policy or an encryption key associated with the first resource.

28. The non-transitory computer-readable medium of any of clauses 21-27, in which the access control policy specifies that the entity has access privileges to the first resource and the controller unit denies access to the first entry if the first identifier does not match the first owner information.

29. An apparatus, comprising:
means for receiving, by a controller unit, a request by an entity to access a first entry in a resource tracking table, the first entry corresponding to a first resource of a computing system;
means for detecting a first identifier associated with the entity;
means for comparing, by the controller unit, the first identifier with first owner information specified in the first entry of the resource tracking table; and
means for controlling, by the controller unit, access from the entity to the first entry based on the comparing.

30. The apparatus of clause 29, in which the controlling means denies the entity access to the first entry if the first identifier does not match the first owner information.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. An apparatus, comprising:
at least one memory for storing a resource tracking table; and
a controller unit coupled to the at least one memory, the controller unit is configured to:
receive a request by an entity to access a first entry in the resource tracking table, the first entry corresponding to a first resource of a computing system;
detect a first identifier associated with the entity;
compare the first identifier with first owner information specified in the first entry of the resource tracking table; and
control access from the entity to the first entry based on the comparing.

2. The apparatus of claim 1, in which the entity has a higher privilege level than a privilege level associated with the first resource of the first entry and the controller unit denies access to the first entry by the entity if the first identifier does not match the first owner information.

3. The apparatus of claim 1, in which the controller unit permits the entity to access or modify the first entry if the first identifier matches the first owner information.

4. The apparatus of claim 1, in which the entity has access privileges for at least a second resource in a same domain as the first resource of the first entry and the controller unit denies access by the entity.

5. The apparatus of claim 1, in which the entity has a lower privilege level than a privilege level of the first resource of the first entry and the controller unit permits the entity to update the first entry based on the comparing.

6. The apparatus of claim 1, in which the first entry includes a set of properties associated with the first resource and the controller unit denies access to the first entry corresponding to the first resource if the first identifier does not match the first owner information.

7. The apparatus of claim 6, in which the set of properties include one or more of an access control policy or an encryption key associated with the first resource.

8. The apparatus of claim 7, in which the access control policy specifies that the entity has access privileges to the first resource and the controller unit denies access to the first entry if the first identifier does not match the first owner information.

9. The apparatus of claim 1, in which the first entry is stored in memory or register files associated with an initiator.

10. The apparatus of claim 1, in which the resource tracking table includes a second entry corresponding to a second resource and the first owner information of the first entry is different than a second owner information of the second entry.

11. A method for updating a resource tracking table comprising:
receiving, by a controller unit, a request by an entity to access a first entry in the resource tracking table, the first entry corresponding to a first resource of a computing system;
detecting a first identifier associated with the entity;
comparing, by the controller unit, the first identifier with first owner information specified in the first entry of the resource tracking table; and
controlling, by the controller unit, access from the entity to the first entry based on the comparing.

12. The method of claim 11, in which the entity has a higher privilege level than a privilege level associated with the first resource of the first entry and the controller unit denies access to the first entry by the entity if the first identifier does not match the first owner information.

13. The method of claim 11, in which the controller unit permits the entity to access or modify the first entry if the first identifier matches the first owner information.

14. The method of claim 11, in which the entity has access privileges for at least a second resource in a same domain as the first resource of the first entry and the controller unit denies access by the entity.

15. The method of claim 11, in which the entity has a lower privilege level than a privilege level of the first resource of the first entry and the controller unit permits the entity to update the first entry based on the comparing.

16. The method of claim 11, in which the first entry includes a set of properties associated with the first resource and the controller unit denies access to the first entry corresponding to the first resource if the first identifier does not match the first owner information.

17. The method of claim 16, in which the set of properties include one or more of an access control policy or an encryption key associated with the first resource.

18. The method of claim 17, in which the access control policy specifies that the entity has access privileges to the first resource and the controller unit denies access to the first entry if the first identifier does not match the first owner information.

19. The method of claim 11, in which the first entry is stored in memory or register files associated with an initiator.

20. The method of claim 11, in which the resource tracking table includes a second entry corresponding to a second resource and the first owner information of the first entry is different than a second owner information of the second entry.

21. A non-transitory computer-readable medium having program code recorded thereon, the program code executed by a processor and comprising:
program code to receive, by a controller unit, a request by an entity to access a first entry in a resource tracking table, the first entry corresponding to a first resource of a computing system;
program code to detect a first identifier associated with the entity;
program code to compare, by the controller unit, the first identifier with first owner information specified in the first entry of the resource tracking table; and
program code to control, by the controller unit, access from the entity to the first entry based on the comparing.

22. The non-transitory computer-readable medium of claim 21, in which the entity has a higher privilege level than a privilege level associated with the first resource of the first entry and the controller unit denies access to the first entry by the entity if the first identifier does not match the first owner information.

23. The non-transitory computer-readable medium of claim 21, in which the controller unit permits the entity to access or modify the first entry if the first identifier matches the first owner information.

24. The non-transitory computer-readable medium of claim 21, in which the entity has access privileges for at least a second resource in a same domain as the first resource of the first entry and the controller unit denies access by the entity.

25. The non-transitory computer-readable medium of claim 21, in which the entity has a lower privilege level than a privilege level of the first resource of the first entry and the controller unit permits the entity to update the first entry based on the comparing.

26. The non-transitory computer-readable medium of claim 21, in which the first entry includes a set of properties associated with the first resource and the controller unit denies access to the first entry corresponding to the first resource if the first identifier does not match the first owner information.

27. The non-transitory computer-readable medium of claim 26, in which the set of properties include one or more of an access control policy or an encryption key associated with the first resource.

28. The non-transitory computer-readable medium of claim 27, in which the access control policy specifies that the entity has access privileges to the first resource and the controller unit denies access to the first entry if the first identifier does not match the first owner information.

29. An apparatus, comprising:
means for receiving, by a controller unit, a request by an entity to access a first entry in a resource tracking table, the first entry corresponding to a first resource of a computing system;
means for detecting a first identifier associated with the entity;
means for comparing, by the controller unit, the first identifier with first owner information specified in the first entry of the resource tracking table; and
means for controlling, by the controller unit, access from the entity to the first entry based on the comparing.

30. The apparatus of claim 29, in which the controlling means denies the entity access to the first entry if the first identifier does not match the first owner information.
